(19) United States
(12) Patent Application Publication
(10) Pub. No.: US 2009/0000129 A1
(43) Pub. Date: Jan. 1, 2009

(54) SAFETY SCISSORS

(76) Inventor: Masako NAKAKOSHI, Matsumoto-shi (JP)

Correspondence Address: BUCHANAN, INGERSOLL & ROONEY PC, POST OFFICE BOX 1404, ALEXANDRIA, VA, 22313-1404, US

(21) Appl. No.: 11/768,345

(22) Filed: Jun. 26, 2007

(51) Int. Cl. B26B 13/12; B26B 13/00; B26B 13/06

(52) U.S. Cl. 30/232; 30/250; 30/346

(57) ABSTRACT

Left and right blades (4, 5) of children's scissors (1) are metal plates of a substantially constant thickness in their entirety. Outer peripheral end surfaces (4b, 5b) of distal end parts (4a, 5a) of the blades (4, 5) are end surfaces of a fixed width in which one end is uninterruptedly connected to distal ends (2a, 3a) of cutting blades (2, 3). A contour form of the outer peripheral end surfaces (4b, 5b) is defined by convex curves (C1, C2). The distal end parts (4a, 5a) of the blades (4, 5) form a heart-shaped contour form C in a state in which the blades (4, 5) are closed and the cutting blades (2, 3) are brought together. Even while the children's scissors (1) are open, there is no danger of an injury being caused by a sharp corner of the cutting blades becoming exposed and a finger tip or other body part coming into contact with the cutting blades, which is a problem in conventional scissors, and safety is achieved.

### TECHNICAL FIELD

The present invention relates to children's scissors or other safety scissors that do not cause injuries when used by children or others.

### RELATED ART DESCRIPTION

Distal end portions of left and right blades of conventional children's scissors are rounded. In a closed state, the left and right rounded end surfaces are brought together. Instances of fingers or other body parts coming into contact with tips of the blades and suffering injury will not occur.

However, when the left and right blades are open, sharp tips of cutting blades formed along inside edges of the blades are exposed. There is a great risk that a finger tip will come into contact with these tips and will be injured.

### SUMMARY OF THE INVENTION

It is an object of the present invention to provide children's scissors or other safety scissors in which a contour form of a distal end portion is defined so that a sharp corner is not formed on a distal end of a blade in a blade angle direction.

In order to resolve the foregoing problem, preferably, the safety scissors of the present invention are characterized in comprising: a left blade and a right blade having cutting blades formed on mutually facing inside edge parts; a rotation support shaft for connecting the left blade and right blade together in an openable and closable state so that the cutting blades of the left blade and right blade slide across one another; and a left side handle and a right side handle into which fingers are inserted, the handles being attached at a position further toward a rear end side of the left blade and right blade than the rotation support shaft; wherein the blades are of a substantially fixed thickness in their entirety; outer peripheral end surfaces of the distal end parts of the blades are end surfaces of a fixed width in which one end is uninterruptedly connected to the distal ends of the cutting blades; and a contour form of the outer peripheral surfaces is defined by a convex curve.

The distal end parts of the blades preferably form a heart-shaped contour form in a state in which the blades are closed and the cutting blades have been brought together.

The distal end portions of the blades of the safety scissors of the present invention are of a uniform thickness. The contour form of the distal end portions are defined by a convex curve connected uninterruptedly to a tip of the cutting blades of the blades. Therefore, a state is realized in which the tips of the cutting blades are not sharp corners, and the outer peripheral edge surfaces of fixed thickness are connected. In other words, the tips of the cutting blades are situated to the rear of the tips of the distal end portions of the blades. Therefore, an injury will not occur even when a finger tip or the like makes contact with this portion.

Therefore, according to the present invention, the tip of the cutting blades can be prevented from cutting a finger or the like during use and the tips of the cutting blades of the closed blades can be prevented from cutting the skin.

### BRIEF DESCRIPTION OF THE DRAWINGS

FIG. 1 is a plan view showing children's scissors according to a first embodiment that utilizes the present invention;

FIG. 2 is a side view of the children's scissors of FIG. 1; and

FIG. 3 is a plan view of a state in which the children's scissors of FIG. 1 are open.

### DESCRIPTION OF THE PREFERRED EMBODIMENTS

An embodiment of safety scissors in which the present invention is used shall be described below with reference to the drawings.

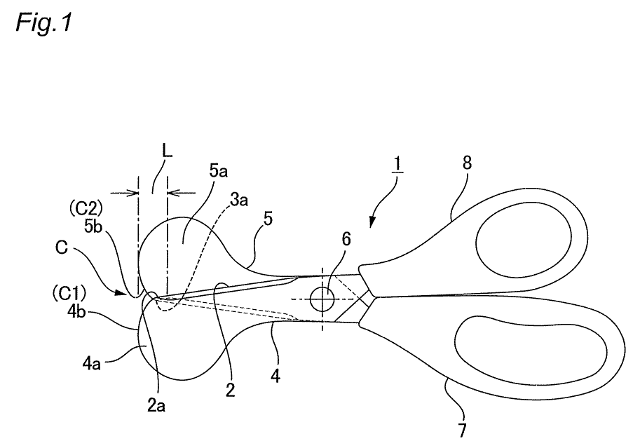

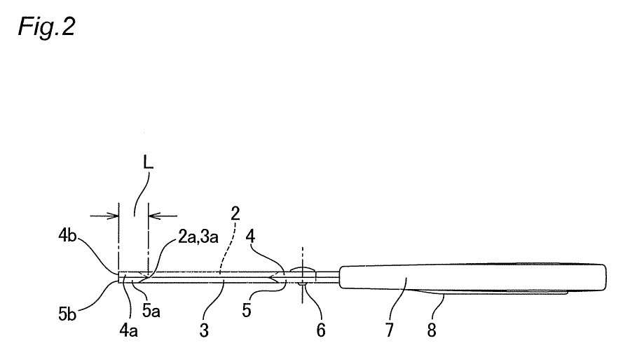

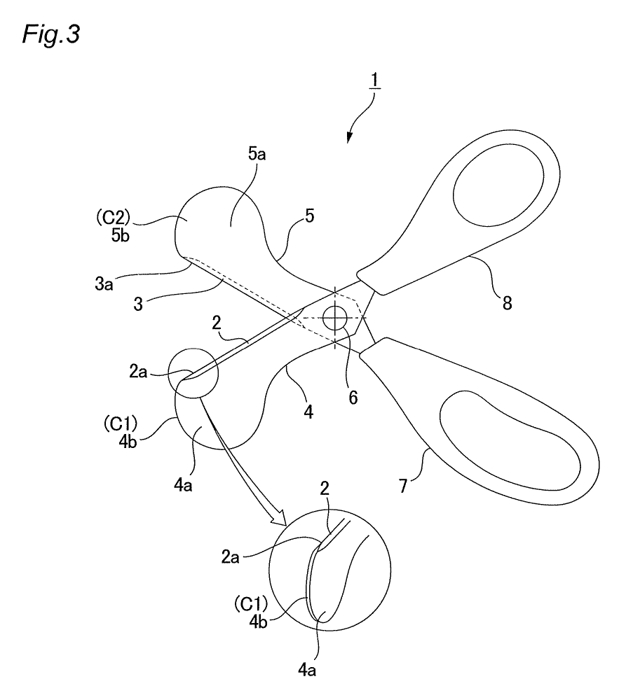

FIG. 1 is a plan view showing children's scissors according to a first embodiment. FIG. 2 is a side view of the scissors. FIG. 3 is a plan view showing an open state.

Children's scissors 1 have a basic configuration similar to typical scissors. The children's scissors comprise a left blade 4 and a right blade 5 on whose edge parts, at mutually facing distal ends, are formed cutting blades 2, 3. The left blade 4 and right blade 5 are connected to one another in a laterally openable and closable state about a rotation support shaft 6 so that the cutting blades 2, 3 slide across each another. A left handle 7 and a right handle 8 into which fingers are inserted are attached at positions further toward the rear end sides of the left blade 4 and the right blade 5 than the rotation support shaft 6. The handles 7, 8 are made of a plastic or other material.

The left blade 4 and right blade 5 are metal plates formed at a substantially fixed thickness overall. Outer peripheral end surfaces 4b, 5b of distal end parts 4a and 5a of the left and right blades 4, 5 are end surfaces of a constant width in which inner ends thereof are connected uninterruptedly to distal ends 2a, 3a of the cutting blades 2, 3. A contour form of the outer peripheral end surfaces 4b, 5b is defined by convex curves C1, C2. In particular, in the present example, the blades 4, 5 are closed and the cutting blades 2, 3 are brought together, in which state [the contour form] is defined by the convex curves C1, C2 so that the distal end parts 4a, 5a of the blades 4, 5 form a heart-shaped contour form C, as shown in FIG. 1.

When the children's scissors 1 having this shape are in a closed state, the distal ends 2a, 3a of the cutting blades 2, 3 of the blades 4, 5 are covered by the left and right outer peripheral end surfaces 4b, 5b, as shown in FIG. 1. In other words, the distal ends 2a, 3a of the cutting blades 2, 3 are situated at positions recessed a distance L from the distal ends of the outer peripheral end surfaces 4b, 5b of the blades 4, 5, and do not make contact with the fingertips or other body parts. Safety is therefore achieved.

In an open state, as shown in FIG. 2, the outer peripheral end surfaces 4b, 5b of fixed width are connected with the distal ends 2a, 3a of the cutting blades 2, 3, and the ends of the outer peripheral end surfaces 4b, 5b are connected uninterruptedly to the distal ends 2a, 3a of the cutting blades 2, 3, Therefore, unlike in the prior art, there is no risk of injury when the sharp corners of the cutting blades 2, 3 are exposed and come into contact with a finger tip or the like. Safety is achieved.

Thus, the children's scissors 1 do not differ from the prior art in terms of usage. However, no risk arises that the distal ends of the children's scissors 1 will stab a child even if the child falls while carrying the scissors. In addition, even if the child swings the scissors about, the incidence of people in the vicinity coming into contact with the blades and being injured can be minimized because the portions of the blade do not have sharp corners.

What is claimed is:

1. Safety scissors characterized in comprising:
a left blade and a right blade having cutting blades formed on mutually facing inside edge parts;
a rotation support shaft for connecting the left blade and right blade together in an openable and closable state so that the cutting blades of the left blade and right blade slide across one another; and
a left side handle and a right side handle into which fingers are inserted, the handles being attached at a position further toward a rear end side of the left blade and right blade than the rotation support shaft; wherein
the blades are of a substantially fixed thickness in their entirety;
outer peripheral end surfaces of the distal end parts of the blades are end surfaces of a fixed width in which one end is uninterruptedly connected to the distal ends of the cutting blades; and
a contour form of the outer peripheral surfaces is defined by a convex curve.

2. The scissors according to claim 1, characterized in that
the distal end parts of the blades form a heart-shaped contour form in a state in which the blades are closed and the cutting blades have been brought together.
